(19) United States
(12) Patent Application Publication
(10) Pub. No.: US 2012/0009369 A1
(43) Pub. Date: Jan. 12, 2012

(54) MEMBRANE, IN PARTICULAR A GAS STORAGE MEMBRANE

(76) Inventors: Jens Storre, Federal (DE); Karl-Heinz Blomeyer, Federal (DE); Alexander Papadimitriou, Federal (DE)

(21) Appl. No.: 13/236,046

(22) Filed: Sep. 19, 2011

Related U.S. Application Data
(63) Continuation of application No. PCT/EP2010/051228, filed on Feb. 2, 2010.

(30) Foreign Application Priority Data
Mar. 30, 2009 (DE) 102009003696.2

(51) Int. Cl. B32B 1/08; B32B 3/02; B29C 65/54; B32B 5/00

(52) U.S. Cl. 428/35.7; 428/195.1; 428/80; 156/304.3

(57) ABSTRACT

The invention relates to a membrane, in particular a gas storage membrane, comprising at least two individual membrane webs that are connected to each other by at least one seam construction, wherein each individual membrane web (4, 4′) comprises at least one elastomeric layer and at least one outer layer based on PTFE. The invention further relates to a method for producing such a membrane.

### CROSS REFERENCE TO RELATED APPLICATIONS

This application is a continuation application of international patent application PCT/EP 2010/051228, filed Feb. 2, 2010, designating the United States and claiming priority from German application 10 2009 003 696.2, filed Mar. 30, 2009, and the entire content of both applications is incorporated herein by reference.

### FIELD OF THE INVENTION

The invention relates to a membrane, in particular to a gas storage membrane.

### BACKGROUND OF THE INVENTION

Membranes are used where two identical or different fluids are separated in a flexible manner or else are to be sealed off from one another. In particular, membranes which are used for separation or sealing in respect of gaseous fluids have to have various properties adjusted appropriately for the respective fluid. If, for example, compressed gases are to be separated from liquids in a flexible manner, it is important that the pressure is retained in the gas. This type of membrane therefore has to have maximum impermeability to gases.

In order to counteract escape of the gas from a gas chamber by diffusion, it is known that the membrane can be designed with maximum impermeability to gases, in particular to nitrogen. By way of example, DE 42 43 652 A1, DE 41 17 411 C2, and DE 36 38 828 A1 disclose that the membrane made of elastomer layers has a gas barrier layer, also termed a barrier layer. Examples of gas barrier layers that can be used here are layers made of polyamide, of polyvinyl alcohol, or of ethylene-vinyl alcohol copolymers. Membranes with such gas barrier layers have a relatively short lifetime, that is, often exhibit permanent expansion of the membrane after prolonged use, since the gas barrier layer does not generally have the elastic behavior of the surrounding elastomer sublayers, and therefore succumbs to permanent expansion.

DE 44 46 304 A1 discloses an increased lifetime of membranes for diaphragm pumps or diaphragm valves comprising PTFE. The PTFE layer here is directly connected to a textile layer via hot-pressing. However, the lifetime in DE 44 46 304 A1 does not relate to impermeability to gases, but instead relates to the load cycles and flexing cycles necessary for diaphragm pumps or diaphragm valves.

Membranes for sealing large-volume containers, for example those needed in biogas systems, are known by way of example from DE 20 2007 007 060 U1 and United States patent application publication 2007/0023440. DE 20 2007 007 060 U1 provides the attachment of a sealable external passage aperture to counter the risk represented by excessively high and excessively low pressure, in order to maintain lifetime, that is, to reduce or avoid damage, in this type of gas storage membrane. United States patent application publication 2007/0023440 describes the attachment of an additional net in order, for example, to avoid tearing of a gas storage foil in the outdoor sector. Both in essence involve a measure for maintaining mechanical lifetime rather than for maintaining chemical lifetime or chemical stability.

### SUMMARY OF THE INVENTION

It is therefore an object of the invention to provide a flexible membrane, in particular a flexible gas storage membrane, which features good chemical stability and long lifetime with improved cost-effectiveness.

The invention achieves the object via a membrane which is characterized in that it is composed of at least two individual membrane webs which have been connected to one another via at least one seam structure, where each individual membrane web comprises at least one elastomer layer and at least one external layer based on PTFE.

For the purposes of the present invention, “PTFE-based” means polytetrafluoroethylene (PTFE), modified polytetrafluoroethylene. (TFM), fluoroethylene polymer (FEP), perfluorinated alkyl vinyl ether-tetraethylene copolymer (PFA), or ethylene-tetrafluoroethylene copolymer (ETFE). It is preferable that PTFE or TFM is involved here.

Surprisingly, it has been found that this type of membrane, in particular this type of gas storage membrane, features good impermeability to gases and especially increased lifetime, and consequently improved cost-effectiveness.

The membrane of the invention is preferably used for sealing coke-oven gases, also termed coking-plant gases, and is preferably used in gas storage systems of the Wiggins type.

A further advantage is that environmental pollution is significantly reduced, and there is therefore then no need to dispose of contaminated seal oils, and there is therefore no need for pumping units for the continuous circulation of the seal oil. This type of membrane moreover represents an elastic system with good resilience which can react flexibly to variations in gas volumes and in gas pressures without mechanical and chemical impairment.

Coke-oven gas comprises in essence hydrogen, methane, nitrogen, carbon monoxide, carbon dioxide, hydrogen sulfide, ammonia, and lower and higher hydrocarbons. It is produced by pyrolysis of coal. Coal, as starting material, is a natural product of varying constituents, and the constitution of coke-oven gas is therefore in each case different, but it is always aggressive to the extent that inhalation or skin contact is often life-threatening to organisms, humans or other animals.

This aggressive character is also apparent from the fact that some of the coke-oven gases can diffuse through a membrane composed only of elastomer layers and sometimes of a laid scrim layer, woven layer, or knitted layer, and can also destroy these layers.

If a sealing membrane is used that is merely a PTFE-based foil, the result is firstly extremely high costs and lack of tensile strength, together with low overall strength, and secondly no stabilization of the plunger in the gas storage system, for example, with respect to torsion.

The membrane of the invention is therefore composed of at least two individual membrane webs which have been connected to one another via at least one seam structure, where each individual membrane web comprises at least one elastomer layer and at least one external layer based on PTFE.

The number of the layers within the individual membrane web is preferably from two to six, and in one particularly preferred embodiment the individual membrane web has four layers.

It has proven advantageous for the individual membrane web to comprise at least one elastomer layer and at least one external layer based on PTFE, and at least one laid scrim layer or woven layer or knitted layer, where the laid scrim layer or woven layer or knitted layer has been connected on at least one side to an elastomer layer.

The elastomer layer is preferably a rubber mixture based on chloroprene rubber and/or on ethylene-propylene rubber and/or on ethylene-propylene-diene rubber and/or on nitrile rubber and/or on halonitrile rubber and/or on fluoro rubber and/or on silicone rubber and/or on chlorinated polyethylene and/or on chlorosulfonated polyethylene. The quantitative proportion of the abovementioned rubber(s) is advantageously from 50 to 100 phr.

It is preferable that from 50 to 100 phr of chloroprene rubber are involved here.

The quantifier phr (parts per hundred parts of rubber by weight) is the conventional quantity for mixing formulations in the rubber industry. The parts by weight added of the individual substances here are always based on 100 parts by weight of the entire composition of all of the rubbers present in the rubber mixture. The thickness of the elastomer layer is from 0.2 to 1.3 mm, preferably from 0.4 to 1.0 mm. If more than one elastomer layer is used, the thicknesses of these can be either identical or different. Likewise, if there is more than one elastomer layer present, the qualitative and/or quantitative constitution of the individual elastomer layers can be identical or different.

The laid scrim layer or woven layer or knitted layer is preferably composed of polyamide yarn and/or polyester yarn and/or aramid yarn and/or cotton yarn and/or glass fibers and/or metal yarn, and particular preference is given here to polyamide yarn. The thickness of the laid scrim layer or woven layer or knitted layer is preferably from 0.1 to 0.5 mm, particularly preferably from 0.2 to 0.4 mm, while the thickness of the external layer based on PTFE is preferably from 0.05 to 0.5 mm, particularly preferably from 0.1 to 0.3 mm.

If more than one laid scrim layer or woven layer or knitted layer is used, the thicknesses thereof can be either identical or different. Likewise, if more than one laid scrim layer or woven layer or knitted layer is present, these can be composed of respectively identical or different abovementioned materials.

It is moreover advantageous for the PTFE-based external layer to have been etched on both sides. As a result of good chemical coupling, the double-sided etching of the external layer provides a stable seam structure and very small layer thicknesses. The latter can provide reversible expansion of layers including the external layer and, in the event of such expansion, inhibits separation of the external layer from the elastomer layer or from a laid scrim layer or woven layer or knitted layer. The bilateral etching has no effect on the excellent shielding provided by the external layer in relation, in particular, to the aggressive coke-oven gases. Any of the etching processes known to the person skilled in the art can be used here for the double-sided etching of the external layer.

Another factor of great importance is the seam structure of a membrane which is in particular used for gas storage systems. The person skilled in the art is aware that the seams, which are usually designed as overlapping seams and are welded and/or adhesive-bonded at low temperature, are one of the significant sites of weakness of a membrane. The membrane advantageously features a particular seam structure. This seam structure is composed of at least two individual membrane webs that have been placed in abutment, where layers of the same type of the individual membrane webs have respectively been placed in abutment, and where, on that external side of the membrane at which the elastomer layers of individual membrane webs have respectively been placed in abutment, the two membrane webs have been connected to one another by way of a superposed sheet and by way of a first rubber matrix, and on the other external side, at which the external layers of the individual membrane webs have been respectively placed in abutment, these have been connected to one another by way of a superposed layer based on PTFE, and by way of a second rubber matrix.

The total layer thicknesses of the individual membrane webs should be identical given that they are placed in abutment.

It is self-evident that the respective width of the superposed sheet and the width of the superposed layer have to be smaller than the width of the individual membrane webs, taking the narrowest membrane web as a starting point.

It has proven to be advantageous here for the width of the superposed sheet and/or the width of the superposed layer to be respectively from 2 to 20 cm, preferably from 5 to 15 cm.

In one preferred embodiment, the superposed sheet is a vulcanized or unvulcanized sheet. However, it is advantageously an unvulcanized sheet.

It is moreover advantageous for the constitution and structure of the superposed sheet to correspond to the constitution and/or the structure of at least one membrane web. The thickness of the superposed sheet can be identical with or different from the total thickness of the individual membrane webs after deduction of the external layer.

In one particular embodiment, the superposed layer is composed of polytetrafluoroethylene, (PTFE) or of modified polytetrafluoroethylene (TFM). The material and/or thickness of the superposed layer can respectively be identical with or different from the material and/or the thickness of the external layer. It is advantageous for at least the material of the superposed layer to be identical with the material of the external layer.

Again, it is advantageous for the superposed layer to have been etched on both sides.

As a result of good chemical coupling, the double-sided etching of the superposed layer provides for a stable seam structure and very small layer thicknesses. The latter allows for a reversible expansion of the superposed layer and, in the event of such expansion, inhibits separation of the superposed layer from the second rubber matrix and/or the external layer. The bilateral etching has no effect on the excellent shielding provided by the superposed layer in relation, in particular, to the aggressive coke-oven gases. Any of the etching processes known to the person skilled in the art can be used here for the double-sided etching of the superposed layer.

The rubber matrices of the first rubber matrix and of the second rubber matrix preferably comprise chloroprene rubber and/or ethylene-propylene rubber and/or ethylene-propylene-diene rubber and/or nitrile rubber and/or halonitrile rubber and/or fluoro rubber and/or silicone rubber and/or chlorinated polyethylene and/or chlorosulfonated polyethylene. In one particularly preferred embodiment, the rubber matrix of the second rubber matrix comprises fluoro rubber (FKM).

The respective constitutions of the two rubber matrices here can be qualitatively and/or quantitatively identical or different.

It is moreover advantageous for the superposed sheet to be free from PTFE-based materials on the side facing the individual membrane webs.

The shape of the novel membrane is preferably hollow-cylindrical or toroidal, or conical with a total circumference of from 5 to 300 m, preferably from 10 to 200 m. However, a combination of the abovementioned shapes is alto possible.

Production of the membrane encompasses at least the following steps:
production of at least two individual membrane webs, where the external PTFE-based layer of the individual membrane web is applied in the form of a foil during the vulcanization of the individual membrane web;
vulcanization of the individual membrane web;
placing the individual vulcanized membrane webs in abutment, where layers of the same type of the individual vulcanized membrane webs are placed in abutment, respectively;
connection of the individual vulcanized membrane webs by way of a seam structure in such a way that, on that external side of the membrane at which the elastomer layers of the individual membrane webs have respectively been placed in abutment, a sheet and a first rubber matrix are applied, and on the other external side at which the PTFE-based external layers of the individual membrane webs have respectively been placed in abutment, a layer which is based on PTFE, and a second rubber matrix are applied;
vulcanization of the seam structure via hot-pressing.

It is advantageous here for the vulcanization of the individual membrane web and/or the vulcanization of the seam structure to take place at a temperature from 140 to 190° C.

The process described above achieves a seam structure which permits vulcanized connection between the individual membrane webs in such a way that almost no loss of strength exists at these sites and any potential expansion is realized in essence across the area of the membrane.

When the membrane of the invention is used, in particular in the form of a gas storage membrane, for sealing with respect to coke-oven gases, the side facing toward the gas or the gas mixture is that side of the membrane which comprises materials based on PTFE.

### BRIEF DESCRIPTION OF THE DRAWINGS

The invention will now be described with reference to the drawings wherein:

FIG. 1 shows a cross section through an individual membrane web; and,

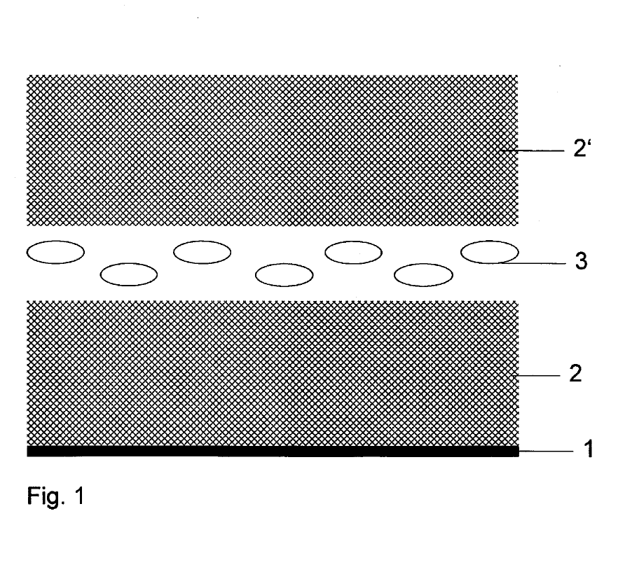

FIG. 2 shows a cross section through a seam structure.

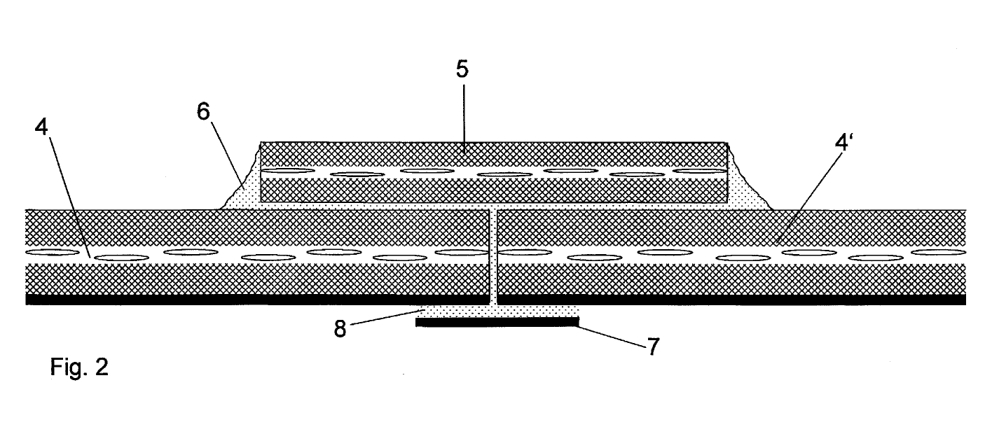

### DESCRIPTION OF THE PREFERRED EMBODIMENTS OF THE INVENTION

The following key applies to the figures:

1 External layer

2, 2′ Elastomer layer

3 Laid scrim layer or woven layer or knitted layer

4, 4′ Membrane web

5 Superposed sheet (strip)

6 First rubber matrix

7 Superposed layer

8 Second rubber matrix

It is understood that the foregoing description is that of the preferred embodiments of the invention and that various changes and modifications may be made thereto without departing from the spirit and scope of the invention as defined in the appended claims.

What is claimed is:

1. A membrane, comprising at least two individual membrane webs which have been connected to one another via at least one seam structure, where each individual membrane web comprises at least one elastomer layer and at least one external layer based on polytetrafluoroethylene (PTFE).

2. The membrane as claimed in claim 1, wherein the number of the layers within the individual membrane web is from two to six.

3. The membrane as claimed in claim 1, wherein the number of the layers within the individual membrane web is four.

4. The membrane as claimed in claim 1, wherein each individual membrane web further comprises at least one laid scrim layer or woven layer or knitted layer, where the laid scrim layer or woven layer or knitted layer has been connected on at least one side to an elastomer layer.

5. The membrane as claimed in claim 1, wherein the elastomer layer is a rubber mixture based on chloroprene rubber and/or on ethylene-propylene rubber and/or on ethylene-propylene-diene rubber and/or on nitrile rubber and/or on halonitrile rubber and/or on fluoro rubber and/or on silicone rubber and/or on chlorinated polyethylene and/or on chlorosulfonated polyethylene.

6. The membrane as claimed in claim 5, wherein the elastomer layer comprises from 50 to 100 phr of chloroprene rubber and/or ethylene-propylene rubber and/or ethylene-propylene-diene rubber and/or nitrile rubber and/or halonitrile rubber and/or fluoro rubber and/or silicone rubber and/or chlorinated polyethylene and/or chlorosulfonated polyethylene.

7. The membrane as claimed in claim 6, wherein the elastomer layer comprises from 50 to 100 phr of chloroprene rubber.

8. The membrane as claimed in claim 1, wherein the thickness of the elastomer layer is from 0.2 to 1.3 mm.

9. The membrane as claimed in claim 4, wherein the laid scrim layer or woven layer or knitted layer is composed of polyamide yarn and/or polyester yarn and/or aramid yarn and/or cotton yarn and/or glass fibers and/or metal yarn.

10. The membrane as claimed in claim 9, wherein the laid scrim layer or woven layer or knitted layer is composed of polyamide yarn.

11. The membrane as claimed in claim 9, wherein the thickness of the laid scrim layer or woven layer or knitted layer is from 0.1 to 0.5 mm.

12. The membrane as claimed in claim 1, wherein the thickness of the external layer is from 0.05 to 0.5 mm.

13. The membrane as claimed in claim 12, wherein the thickness of the external layer is from 0.1 to 0.3 mm.

14. The membrane as claimed in claim 1, wherein the external layer has been etched on both sides.

15. The membrane as claimed in claim 1, wherein the seam structure is composed of at least two individual membrane webs that have been placed in abutment, where layers of the same type of the individual membrane webs have respectively been placed in abutment, and where, on that external side of the membrane at which the elastomer layers of individual membrane webs have respectively been placed in abutment, the two membrane webs have been connected to one another by way of a superposed sheet and by way of a first rubber matrix, and on the other external side, at which the external layers of the individual membrane webs have been respectively placed in abutment, these have been connected to one another by way of a superposed layer based on PTFE, and by way of a second rubber matrix.

16. The membrane as claimed in claim 15, wherein the width of the superposed sheet and/or of the superposed layer is respectively from 2 to 20 cm.

17. The membrane as claimed in claim 15, wherein the superposed layer has been etched on both sides.

18. The membrane as claimed in claim 15, wherein the second rubber matrix comprises fluoro rubber.

19. The membrane as claimed in claim 15, wherein the superposed sheet is free from PTFE-based materials on a side facing toward the individual membrane webs.

20. The membrane as claimed in claim 1, wherein a shape of the membrane is selected from the group consisting of hollow-cylindrical, toroidal, and conical.

21. The membrane as claimed in claim 1, wherein a, total circumference of the membrane is from 5 to 300 m.

22. The membrane as claimed in claim 21, wherein the total circumference is from 10 to 200 m.

23. A process for producing a membrane as claimed in claim 1, comprising:
producing at least two individual membrane webs;
vulcanizing the at least two individual membrane webs, wherein an external PTFE-based layer of the individual membrane web is applied in the form of a foil during the vulcanizing of the individual membrane web;
placing the individual vulcanized membrane webs in abutment, where layers of a same type of the individual vulcanized membrane webs are placed in abutment, respectively;
connecting the individual vulcanized membrane webs by way of a seam structure in such a way that, on that external side of the membrane at which the elastomer layers of the individual membrane webs have respectively been placed in abutment, a sheet and a first rubber matrix are applied, and on the other external side at which the PTFE-based external layers of the individual membrane webs have respectively been placed in abutment, a layer which is based on PTFE, and a second rubber matrix are applied; and,
vulcanizing the seam structure via hot-pressing.

24. The process for producing a membrane as claimed in claim 23, wherein the vulcanization of the individual membrane web and/or the vulcanization of the seam structure take(s) place at a temperature from 140 to 190° C.

25. A method of storing a gas in a gas storage system, comprising sealing the gas storage system with a membrane as claimed in claim 1.

26. The method as claimed in claim 25, wherein the gas comprises coke-oven gas.

27. The method as claimed in claim 25, wherein the gas storage system is a Wiggins gas storage system.
